(19) United States
(12) Patent Application Publication
(10) Pub. No.: US 2025/0015307 A1
(43) Pub. Date: Jan. 9, 2025

(54) LENS-SHAPED POROUS SUPPORT FOR FUEL CELL CATALYSTS AND MANUFACTURING METHOD THEREOF

(71) Applicants: HYUNDAI MOTOR COMPANY, SEOUL (KR); KIA CORPORATION, SEOUL (KR); KOREA ADVANCED INSTITUTE OF SCIENCE AND TECHNOLOGY, DAEJEON (KR)

(72) Inventors: Ji Hoon Yang, Hwaseong-si (KR); Jin Seong Choi, Suwon-si (KR); Kook Il Han, Seongnam-si (KR); Geon Hee Cho, Uijeongbu-si (KR); Jin Woo Lee, Daejeon (KR); Ah Ryeon Lee, Daejeon (KR); Dong Yoon Woo, Daejeon (KR)

(21) Appl. No.: 18/530,910

(22) Filed: Dec. 6, 2023

(30) Foreign Application Priority Data
Jul. 5, 2023 (KR) 10-2023-0087305

(51) Int. Cl. H01M 4/86; H01M 4/88

(52) U.S. Cl. CPC H01M 4/8626; H01M 4/8652; H01M 4/8803; H01M 4/8817

(57) ABSTRACT

A lens-shaped porous support for fuel cell catalysts may improve electrochemical performance and increase mass transfer capability when the porous support is used as a carrier to support a fuel cell catalyst.

### CROSS REFERENCE TO RELATED APPLICATIONS

This application claims under 35 U.S.C. § 119(a) the benefit of priority to Korean Patent Application No. 10-2023-0087305 filed on Jul. 5, 2023, the entire contents of which are incorporated herein by reference.

### BACKGROUND

### (a) Technical Field

The present disclosure relates to a lens-shaped porous support for fuel cell catalysts which may improve electrochemical performance and increase mass transfer capability when the porous support is used as a carrier to support a fuel cell catalyst, and a manufacturing method thereof.

### (b) Background Art

Porous carbon materials have a high industrial utility value, and are applied to various fields. For example, porous carbon materials are used as a selective adsorbent in a separation process, adsorption removal and gas storage, an electrode material in batteries, fuel cells and high-capacity capacitors, and a catalyst carrier or a catalyst in main catalyst processes.

Depending on definitions in the International Union of Pure and Applied Chemistry (IUPAC), the porous carbon materials may be classified into three types, i.e., a microporous carbon material having micropores (a pore size<2 nm), a mesoporous carbon material having mesopores (2 nm<a pore size<50 nm), and a macroporous carbon material having macropores (a pore size>50 nm). Particularly, a compromise between increase in an active area through a high specific surface area and maintenance of proper electrical conductivity in the electrochemical application field is mentioned as a big issue. Further, control of a pore size relating to smooth entry and exit of ions and molecules is the main point of discussion.

As one manufacturing method of a mesoporous carbon material, a template method, in which the mesoporous carbon material is manufactured by injecting a polymer or a monomer into a ceramic template having mesopores, performing heat treatment for carbonization, and then removing the ceramic template through acidic or alkaline treatment, is suggested. The mesoporous carbon material manufactured by the template method is advantageous in that mesopores having a uniform size are distributed, and the size of all the mesopores is easily controlled. However, the template, the microstructure of which is finely controlled, for example, formed of a zeolite or mesoporous silica, is difficult to mass-produce, is high-priced, uses hydrofluoric acid to remove the template after manufacture of the mesoporous carbon material, and therefore, it is difficult to mass produce the mesoporous carbon material or to use the mesoporous carbon material as a universal material due to an expensive and cumbersome process.

As another manufacturing method of a mesoporous carbon material, a movable template method, in which the mesoporous carbon material is manufactured by kneading nano-sized ceramic particles with an organic precursor, performing heat treatment for carbonization at a proper temperature, and then removing the ceramic nanoparticles through acidic or alkaline treatment, is used. In this method, the mesoporous carbon material having a precise pore distribution equivalent to the conventional template method may be manufactured using ceramic nanoparticles having a particle size which is uniformly controlled to be several nanometers to several tens of nanometers, and a further manufacturing method of a mesoporous carbon material, in which the mesoporous carbon material may be mass-produced at a low price further using particles of magnesium oxide (MgO), calcium carbonate (CaCO₃), etc. which are relatively easily manufactured and removed, has been developed, but this method has a drawback in which particle sizes are somewhat nonuniform. In this case, measures to prevent nonuniformity in particle distribution (or pore distribution thereby) caused by a material density difference during manufacture of the material, such as use of a larger amount of a nanoparticle material serving as a template than a carbon raw material, use of a surfactant to stabilize particle dispersion, and the like, should be considered.

Recently, in order to solve the drawbacks of the conventional template methods using metal oxides, a soft template method which employs self-assembly using amphiphilic molecules, such as a surfactant or a block copolymer, is gaining attention. A catalyst carrier having mesopores is expected to be suitable for a fuel cell electrode catalyst in terms of smooth entry and exit of reactants and products, particularly, liquid substances, and many cases in which performance of fuel cells is improved by the catalyst carrier have been reported. It is known that the specific surface area, pore size, pore distribution and pore shape of a catalyst carrier for fuel cells, and a functional group on the surface of the catalyst carrier for the purpose of physical and chemical adsorption with a catalyst have an effect on dispersibility of the catalyst and activity of the catalyst, and the catalyst carrier requires electrical conductivity, chemical durability, mechanical strength, and the like.

Carbon black, and carbon materials having various types of nanostructures have been used as catalyst carriers for fuel cell until now, but unmet demand for catalysts having improved electrochemical performance and increased mass transfer capability still exists.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a lens-shaped porous support for fuel cell catalysts which may improve electrochemical performance and increase mass transfer capability when the porous support is used as a carrier to support a fuel cell catalyst.

It is another object of the present disclosure to provide a carrier of a catalyst for fuel cells which includes a lens-shaped porous support for fuel cell catalysts.

It is yet another object of the present disclosure to provide an electrode for fuel cells which includes a lens-shaped porous support for fuel cell catalysts.

It is still another object of the present disclosure to provide a fuel cell which includes a lens-shaped porous support for fuel cell catalysts.

It is still yet another object of the present disclosure to provide a manufacturing method of a lens-shaped porous support for fuel cell catalysts.

In one aspect, the present disclosure provides a porous support for fuel cell catalysts, including a plurality of pores arranged regularly and configured to have an oval or convex lens shape.

In a preferred embodiment, a size of the pores may be 5 to 50 nm.

In another preferred embodiment, a shape of the pores may be one of a cylindrical shape, an elliptical columnar shape, a polygonal columnar shape, and combinations thereof.

In still another preferred embodiment, the pores may include communication channel configured such that the pores communicate with other pores therethrough.

In yet another preferred embodiment, a diameter of the communication channel may be 0.5 to 10 nm.

In still yet another preferred embodiment, a short axis length of the porous support may be 90 to 300 nm, and a long axis length of the porous support may be 300 to 1,000 nm.

In a further preferred embodiment, a surface of the porous support may be hydrophobically modified.

In another aspect, the present disclosure provides a carrier of a catalyst for fuel cells, including a porous support for fuel cell catalysts, including a plurality of pores arranged regularly and configured to have an oval or convex lens shape.

In still another aspect, the present disclosure provides an electrode for fuel cells, including a porous support for fuel cell catalysts, including a plurality of pores arranged regularly and configured to have an oval or convex lens shape.

In yet another aspect, the present disclosure provides a fuel cell including a porous support for fuel cell catalysts, including a plurality of pores arranged regularly and configured to have an oval or convex lens shape.

In a further aspect, the present disclosure provides a manufacturing method of a porous support for fuel cell catalysts, including preparing a mixed solution by mixing an amphiphilic block copolymer, a homopolymer, an organic precursor, an organic solvent, and an inorganic precursor, preparing a composite by performing evaporation-induced self-assembly (EISA) of the mixed solution, and forming the porous support through heat treatment of the composite, wherein the porous support includes a plurality of pores arranged regularly, and is configured to have an oval or convex lens shape.

In a preferred embodiment, the amphiphilic block copolymer may include at least one selected from the group consisting of poly(ethylene oxide)-b-poly(styrene), poly(ethylene oxide)-b-poly(methyl methacrylate), poly(isoprene)-b-poly(ethylene oxide), poly(isoprene)-b-poly(styrene)-b-poly(ethylene oxide), poly(4-tert-butylstyrene)-b-poly(ethylene oxide), and commercial Pluronic block copolymers including P123, F127 and F108.

In another preferred embodiment, the inorganic precursor may include at least one selected from the group consisting of silicon alkoxide (SiOR₄), tetraethyl orthosilicate (TEOS), aluminum-tri-sec-butoxide, and 3-glycidoxylpropyl-trimethoxysilane.

In still another preferred embodiment, the organic precursor may include at least one selected from the group consisting of phenol, phenol-formaldehyde, furfuryl alcohol, resorcinol-formaldehyde, aldehyde, sucrose, glucose, xylose, divinylbenzene, acrylonitrile, vinyl chloride, vinyl acetate, styrene, methacrylate, methyl methacrylate, ethylene glycol dimethacrylate, urea, and melamine.

In yet another preferred embodiment, a mass ratio of the amphiphilic block copolymer to the homopolymer may be 1:3 to 1:10.

In still yet another preferred embodiment, a mass ratio of the amphiphilic block copolymer to the inorganic precursor may be 1:2.5 to 1:5.5.

In a further preferred embodiment, the manufacturing method may further include forming communication channels, and, in forming the communication channels, the porous support may be treated with an alkaline solution or an acidic solution so as to form the communication channels configured such that the pores of the porous support communicate with other pores therethrough.

In another further preferred embodiment, the manufacturing method may further include hydrophobically modifying a surface of the porous support, and, in hydrophobically modifying the surface of the porous support, the surface of the porous support may be hydrophobically modified by heat-treating the porous support at a temperature of 700 to 1,000° C. for 1 to 4 hours while raising a temperature of the porous support at a heating rate of 1 to 5° C./min, in a hydrogen (H₂)/argon (Ar) or hydrogen (H₂)/nitrogen (N₂) mixed gas atmosphere including 3.9% to 20% (v/v %) of hydrogen.

In still another further preferred embodiment, the manufacturing method may further include separating the porous support using a solvent for recovery.

In yet another further preferred embodiment, separating the porous support may further include carbonizing the separated porous support.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a scanning electron microscope (SEM) image of a porous support according to one embodiment of the present disclosure;

FIG. 2 shows an enlarged SEM image of the porous support according to one embodiment of the present disclosure;

FIGS. 3A, 3B, 3C, and 3D show transmission electron microscope (TEM) images of the porous support according to one embodiment of the present disclosure;

FIG. 4 shows an SEM image of a porous support according to Comparative Example 1;

FIG. 5 shows an enlarged SEM image of the porous support according to Comparative Example 1;

FIG. 6 shows an SEM image of a porous support according to Comparative Example 2;

FIG. 7 shows an SEM image of a porous support according to Comparative Example 3;

FIG. 8 shows an SEM image of a porous support according to Comparative Example 4;

FIG. 9 shows an SEM image of a porous support according to Comparative Example 5;

FIG. 10 shows a graph representing results of an ORR test conducted according to one Test Example on porous supports according to Examples 1 and 2 and the porous supports according to Comparative Examples 1 and 2;

FIG. 11 shows a graph representing results of electrochemical characteristics analysis conducted according to one Test Example on half-cells according to Examples 1 and 2 and half-cells according to Comparative Examples 1 and 2; and

FIG. 12 shows a graph representing results of unit cell performance evaluation conducted according to one Test Example.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

A porous support for fuel cell catalysts according to one embodiment of the present disclosure may include a plurality of pores regularly, or evenly, arranged, and may have an oval or convex lens shape.

The pores may be formed on the surface of the porous support.

The porous support may be manufactured by mixing an amphiphilic block copolymer, a homopolymer, and the like, and performing processes, such as evaporation-induced self-assembly and an etching process, and mesopores may be formed by the etching process.

The mesopores may indicate pores generally having a diameter which is greater than 2 nm but less than 50 nm, and the porous support according to the present disclosure may have uniform mesopores having a size of 10 nm to 25 nm.

The pores may have various shapes including a cylindrical shape, an elliptical columnar shape, a polygonal columnar shape, and combinations thereof, and, for example, may have a hexagonal columnar shape, without being limited thereto.

The pores may be regularly arranged in great numbers on the surface of the porous support according to the present disclosure, and any arbitrary pores may include communication channels communicating with other pores. The communication channels are not limited to a specific shape, and may have a diameter of 0.5 to 10 nm.

In one embodiment, the porous support may have an oval shape, or an oval convex lens shape. In this case, the short axis length of the porous support may be 90 to 300 nm, and the long axis length of the porous support may be 300 to 1,000 nm.

In one embodiment, the short axis length of the porous support may be 90 to 150 nm, and the long axis length of the porous support may be 300 to 500 nm.

The surface of the porous support may be hydrophobically modified through heat treatment under hydrogen gas.

In one embodiment, the porous support may be a porous carbon support including carbon.

A manufacturing method of a porous support for fuel cell catalysts according to another embodiment of the present disclosure may include preparing a mixed solution by mixing an amphiphilic block copolymer, a homopolymer, an organic precursor, an organic solvent, and an inorganic precursor, preparing a composite by performing evaporation-induced self-assembly (EISA) of the mixed solution, and forming the porous support through heat treatment of the composite.

The present disclosure relates to a synthesis method of the porous support using both microphase separation occurring when self-assembly of an amphiphilic block copolymer is performed, and macroscopic phase separation occurring when a homopolymer having a relatively high molecular weight and being capable of being mixed with the amphiphilic block copolymer is used.

The amphiphilic block copolymer may include a hydrophilic block and a hydrophobic block, the number-average molecular weight Mₙ of the hydrophilic block may be 4,000 to 6,000 g/mol, and the number-average molecular weight Mₙ of the hydrophobic block may be 15,000 to 40,000 g/mol. When the number-average molecular weights of the hydrophilic functional group and the hydrophobic functional group deviate from the corresponding ranges, microphase separation may occur differently than intended in the present disclosure during the evaporation-induced self-assembly process, or microphase separation occurs nonuniformly overall, and thus, a regular porous structure having a hexagonal columnar shape, intended to be obtained in the present disclosure, may not be obtained. The hexagonal columnar structure may include a hexagonal close-packed (HCP) structure having the regular hexagonal base side, without being limited thereto.

The hydrophilic functional group may have a rather narrow number-average molecular weight range so as to be mixed well with inorganic precursor particles converted into carbon. However, the hydrophobic functional group may have a rather wide number-average molecular weight range relative to the hydrophilic functional group, and particularly, when the lengths of the functional groups are adjusted, the size of the pores on the surface of the porous support according to the present disclosure may be controlled.

In one embodiment, the amphiphilic block copolymer may be PEO-b-PS having a molecular weight of about 20,000 g/mol.

In one embodiment, the homopolymer may be polymethyl methacrylate (PMMA) having a molecular weight of about 996,000 g/mol. PMMA interacts with the respective functional groups of the amphiphilic block copolymer in a balanced manner in enthalpy, and thereby may form oval or convex lens-shaped porous support particles according to the present disclosure. The number-average molecular weight of PMMA may be somewhat higher than that of the block copolymer, and concretely, may be in the range of 350,000 to 1,000,000 g/mol. The size of the porous support particles tends to increase as the number-average molecular weight of PMMA decreases. However, when PMMA having a number-average molecular weight of less than 350,000 g/mol is used, spinodal separation between PMMA and the block copolymer does not smoothly occur and thus it is difficult to form a regular porous structure, and, when PMMA having a number-average molecular weight exceeding 1,000,000 g/mol is used, problems in progress of a process, such as difficulty in dissolving PMMA in the organic solvent so as to perform evaporation-induced self-assembly, may occur.

In one embodiment, the block copolymer and the homopolymer may be sufficiently agitated for three hours or more, and may thus form a uniform solution phase. When a uniform solution is not formed or the remainder of the block copolymer and the homopolymer is observed as floating matter on the solution, phase separation may not occur properly.

In the present disclosure, the organic precursor may indicate a carbon precursor and, in one embodiment, the carbon precursor may be a resol precursor including phenol-formaldehyde.

In one embodiment, the organic solvent may be tetrahydrofuran (THF) or chloroform (CH₃Cl). In the present disclosure, tetrahydrofuran (THF), chloroform, or both tetrahydrofuran (THF) and chloroform may be used as the organic solvent. For example, even if only one of the two kinds of solvents is used, mesopores may be smoothly formed by adjusting the amount of the polymers and the precursors which are dissolved in the organic solvent. However, when components of the organic solvent and the content of the solvent are adjusted, the size of the porous support particles intended in the present disclosure may be controlled by adjusting a time required for evaporation-induced self-assembly. That is, the present disclosure may make up for difficulty in adjusting the size of pores of a support, which is the disadvantage of the conventional hard template method, and difficulty in adjusting the shape and size of a support, which is the disadvantage of the conventional soft template method.

In one embodiment, the inorganic precursor may be an aluminosilicate sol, and the aluminosilicate sol may be a mixture of aluminum-tri-sec-butoxide and 3-glycidoxylpropyl-trimethoxysilane.

In one embodiment, in the preparation of the mixed solution, a polymer solution may be prepared by mixing the amphiphilic block copolymer, the homopolymer, the organic precursor, and the organic solvent, and the inorganic precursor may be added to the polymer solution dropwise. Thereby, the mixed solution may be prepared while adjusting high reactivity of the inorganic precursor.

The polymer solution may be prepared through a mixing process using ultrasonic dispersion or a magnetic agitator, without being limited thereto.

In the description of the present disclosure, “evaporation-induced self-assembly (EISA)” may indicate a technique which produces a nanostructure using bonding between elements or molecules, and may be used to obtain a nanostructure which is naturally formed when a solution evaporates while increasing the concentration of the elements or the molecules in a solution state.

The mass ratio of the amphiphilic block copolymer to the homopolymer may be 1:3 to 1:10, for example, may be 1:7. When the mass ratio of the amphiphilic block copolymer to the homopolymer is less than 1:3, the homopolymer is not capable of sufficiently spatially separating particles of the block copolymer during a spinodal phase separation process, and thus, large block copolymer regions having connectivity to each other are formed, the particle size of the porous support is increased, and nonuniform particles are formed. On the contrary, when the mass ratio of the amphiphilic block copolymer to the homopolymer exceeds 1:7, the block copolymer is not capable of clumping into particles having a proper size during the spinodal phase separation process, and thus, very small block copolymer regions are formed and it is difficult to form mesopores.

The mass ratio of the amphiphilic block copolymer to the inorganic precursor may be 1:2.5 to 1:5.5, for example, 1:4. When the mass ratio of the amphiphilic block copolymer to the inorganic precursor is less than 1:2.5, pores having a lamella structure rather than the hexagonal columnar structure are formed, and thus, mesopores may not be formed or the mesopores and the pores having the lamella structures may be mixed. On the contrary, when the mass ratio of the amphiphilic block copolymer to the inorganic precursor exceeds 1:5.5, pores having an inverse opal structure rather than the hexagonal columnar structure intended in the present disclosure are formed. This structure has no connectivity, and the pores are formed within particles and thus substantially have low electrochemical usefulness.

The preparation of the composite may be performed at a temperature of 45 to 55° C. When the composite is prepared at a temperature of lower than 45° C., spinodal phase separation rapidly progresses due to slow evaporation and relatively large porous support particles are formed, and therefore, such a temperature may not be proper in manufacture of an electrode. On the contrary, when the composite is prepared at a temperature of higher than 45° C., all the mixed solution rapidly evaporates before spinodal phase separation occurs, and thus, proper mesopores may not be formed.

In other words, the particle size of the porous support may be increased by reducing the evaporation rate of the mixed solution, and may be decreased by increasing the evaporation rate of the mixed solution.

In the formation of the porous support, the composite prepared by evaporation-induced self-assembly may be acquired in the type of a film, and the acquired composite film may be annealed at a temperature of 90 to 120° C. for 8 to 12 hours. When the annealing temperature is lower than 90° C. or annealing is performed for a time of less than 8 hours, bonding strength between the precursors is weak, and thus the porous support particles may break down during a process of separating the porous support from the annealed film.

The above-described manufacturing method may further include separating the porous support using a solvent for recovery.

The separation of the porous support may include dispersing the annealed film in the solvent for recovery including THF, chloroform (CH₃Cl), or the like, and selectively separating the porous support through centrifugation. Dispersion of the annealed film in the solvent for recovery may be performed through ultrasonic agitation or magnetic agitation. Here, centrifugation may be performed at 6,000 rpm or more for 30 minutes or more. When centrifugation is performed at lower than 6,000 rpm or is performed for a time shorter than 30 minutes, it is difficult to recover materials.

The separation of the porous support may further include carbonizing the separated porous support.

In the carbonization of the separated porous support, the separated porous support may be heat-treated at a temperature of 700 to 900° C. for 2 to 4 hours in an inert gas atmosphere including argon or nitrogen. When the separated porous support is heat-treated at a temperature of lower than 700° C., the remainder of the block copolymer may not be completely removed, and carbonization may not be performed properly.

In the carbonation of the separated porous support, a heating rate may be 1 to 3° C./min. However, at the heating rate exceeding 3° C./min, the overall heat treatment time is insufficient, and thus, the remainder of the block copolymer may not be completely removed.

The manufacturing method may further include forming communication channels.

In the formation of the communication channels, the communication channels configured such that the pores of the porous support communicate with other pores therethrough may be formed by treating the separated porous support with an alkaline solution or an acidic solution.

The manufacturing method may further comprise hydrophobically modifying the surface of the separated porous support.

In the hydrophobic modification, the surface of the porous support may be hydrophobically modified by heat-treating the separated porous support or the porous support having the communication channels at a temperature of 700 to 1,000° C. for 1 to 4 hours while raising the temperature of the separated porous support at a heating rate of 1 to 5° C./min, in a hydrogen (H₂)/argon (Ar) mixed gas atmosphere or a hydrogen (H₂)/nitrogen (N₂) mixed gas atmosphere including 3.9% to 20% (v/v %) of hydrogen.

The synthesized porous support according to the present disclosure has a pore size of 10 to 25 nm and a uniform lens-shaped shape, and thus, maximizes mass transfer characteristics when used as a carrier for fuel cell catalysts and increases packing density when used to form an electrode, thereby being effective in configuration of the electrode.

Hereinafter, the present disclosure will be described in more detail through the following Manufacturing and Test Examples. The following Manufacturing and Test Examples serve merely to exemplarily describe the present disclosure, and are not intended to limit the scope of the disclosure.

### 1. Manufacturing Example

### 1.1. Manufacture of Porous Carbon Support

0.48 g of a resol precursor including phenol-formaldehyde as an organic precursor was measured and put into a 500 ml glass bottle, and 0.8 g of PEO-b-PS (MW: 20 k) as an amphiphilic block copolymer was added thereto. Thereafter, 5.6 g of pure polymethyl methacrylate (PMMA, MW: 996 k) as a homopolymer was added thereto.

After 25 ml of tetrahydrofuran (THF) and 34 ml of chloroform (CH₃Cl) as a solvent were added thereto, the materials were dispersed in the solvent through ultrasonication and agitation. 2.96 ml of an aluminosilicate solution as an inorganic precursor was added dropwise thereto, and then, a mixed solution was prepared by mixing the reactants for 20 minutes.

A glass petri dish (having a size of 150×25 mm) heated to 50° C. was prepared, 5 ml of the mixed solution was put into the petri dish and was levelled, and a lid was put on the petri dish obliquely so that self-assembly was performed.

A film acquired by naturally drying the mixed solution was collected, and was annealed for 8 hours in an oven heated to 100° C. After the annealed film was dispersed in THF through ultrasonication and was centrifugated, remaining powder was collected. The remaining powder was heat-treated at a temperature of 800° C. and a heating rate of 1° C./min for 2 hours in an argon (Ar) atmosphere. A lens-shaped porous carbon support was prepared by removing aluminosilicate (H₂O:EtOH:49% HF=15:15:10) through etching.

The hydrophobicity of the surface of the prepared lens-shaped porous carbon support was improved by washing the porous carbon support with a mixture of water and ethanol (H₂O:EtOH=1:1), drying the porous carbon support, and heat-treating the porous carbon support at a temperature of 900° C. and a heating rate of 1° C./min for 2 hours in a H₂/Ar atmosphere including 3.9% of hydrogen.

Porous supports according to Example 1 and Comparative Examples 1 to 5 were manufactured by changing four variables set forth in Table 1 below, that is to say, a kind of the used homopolymer, a mass ratio of the block copolymer to the homopolymer, a molecular weight of the hydrophobic functional group, i.e., polystyrene, of the block copolymer, and a mass ratio of the block copolymer to the inorganic precursor. Further, a porous support having the surface, which was not hydrophobic-treated, according to Example 2 was manufactured.

TABLE 1

| | | | Comp. | Comp. | Comp. | Comp. | Comp. |
|---|---|---|---|---|---|---|---|
| Category | Example 1 | Example 2 | example 1 | example 2 | example 3 | example 4 | example 5 |
| Homopolymer | PMMA | PMMA | PMMA | PBMA or | PMMA | PMMA | PMMA |
| | | | not | polystyrene | | | |
| | | | added | | | | |
| Mass ratio of block | 1:7 | 1:7 | 1:7 | 1:7 | 1:2 | 1:7 | 1:7 |
| copolymer:homopolymer | | | | | | | |
| Molecular weight (Mₙ) | 30 k | 30 k | 30 k | 30 k | 30 k | 50 k | 30 k |
| of hydrophobic | | | | | | | |
| functional group of | | | | | | | |
| block copolymer | | | | | | | |
| Mass ratio of block | 1:4 | 1:4 | 1:4 | 1:4 | 1:4 | 1:4 | 1:2 |
| copolymer:inorganic | | | | | | | |
| precursor | | | | | | | |
| Adjustment of | 3.9% H₂, | — | 3.9% H₂, | 3.9% H₂, | 3.9% H₂, | 3.9% H₂, | 3.9% H₂, |
| functional group on | 900° C., | | 900° C., | 900° C., | 900° C., | 900° C., | 900° C., |
| surface | 2 h | | 2 h | 2 h | 2 h | 2 h | 2 h |

1.1. Manufacture of Porous Support on which Platinum Catalyst is Supported

In order to prepare platinum-based nanoparticles, a solution in which 0.4 g of H₂PtCl₆·6H₂O is dissolved in 20 mL of ethylene glycol, and a solution in which 0.4 g of NaOH is dissolved in 20 mL of ethylene glycol were prepared respectively, and were mixed by agitation.

An acquired mixed ethylene glycol solution was heat-treated at a temperature of 160° C. and a heating rate of 4° C./min for 3 hours. 5 mL of the heat-treated solution was put into a conical tube, and platinum nanoparticles were precipitated by repeating washing of the solution using 1M hydrochloric acid (HCl) through a centrifuge. A platinum nanoparticle solution was prepared by dispersing the precipitated platinum nanoparticles in 1 mL of acetone.

74 mg of the carbon support manufactured according to Manufacturing Example 1-1 and 6 mL of acetone were added to the platinum nanoparticle solution and ultrasonicated for 1 hour. The ultrasonicated solution was dried in a vacuum oven for 12 hours (at a constant temperature of 60° C.), was primarily heat-treated at a temperature of 200° C. and a heating rate of 1° C./min for 2 hours in a H₂/Ar atmosphere including 20% of hydrogen, and was secondarily heat-treated at a temperature of 200° C. for 2 hours in an Ar atmosphere. After the temperature was lowered to a temperature of 30° C. or lower, the solution was maintained for 6 hours or more in an O₂/Ar atmosphere including 1% of oxygen.

### 2. Test Example

### 2-1 Appearance Analysis

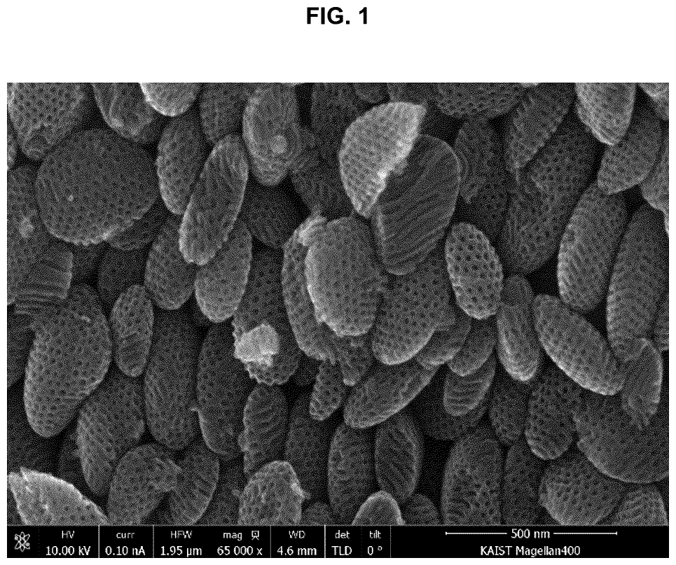

Appearances of the porous carbon supports according to Examples 1 and 2 and Comparative Examples 1 to 5 are shown in FIGS. 1 to 9.

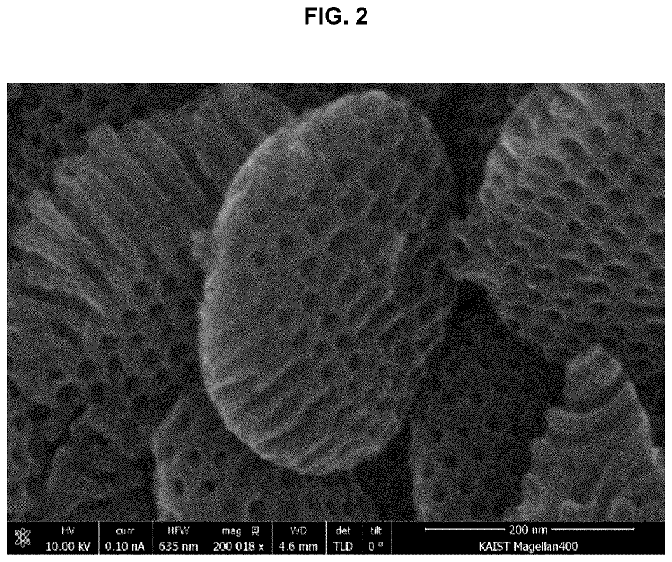

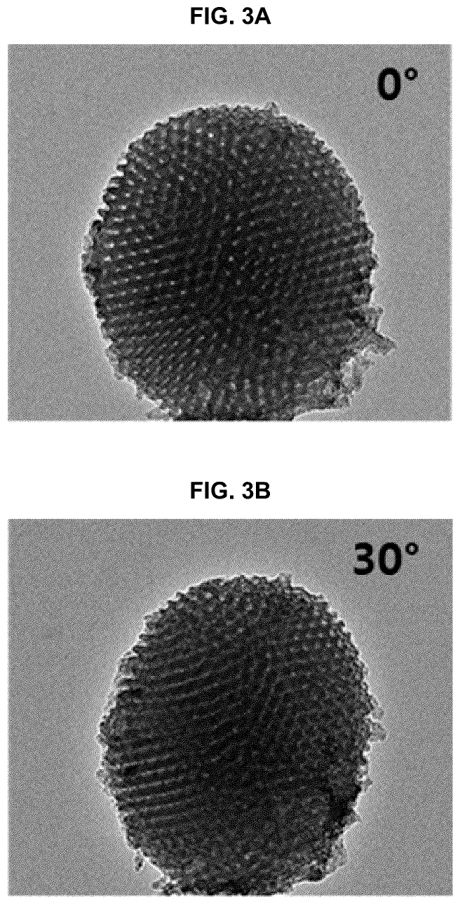

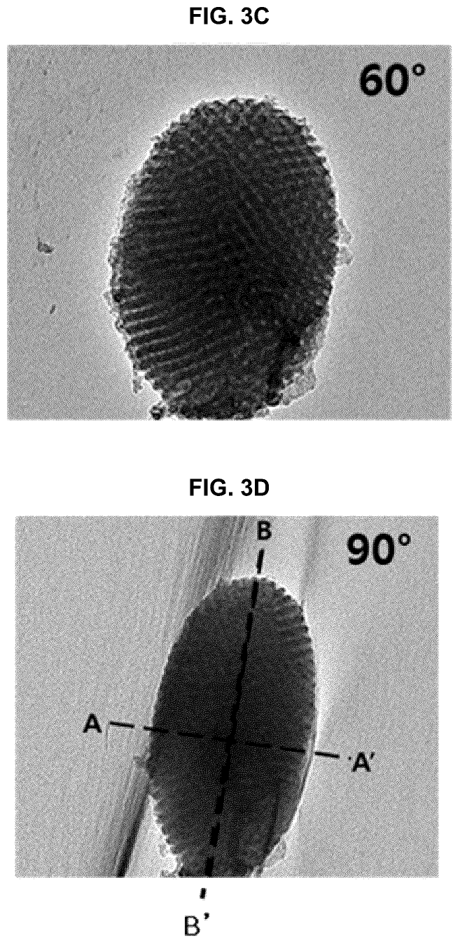

FIGS. 1 and 2 show scanning electron microscope (SEM) images of the porous support according to Example 1, and FIG. 3A to 3D show transmission electron microscope (TEM) images of an arbitrary particle of the porous support according to Example 1, observed while being tilted at specific angles. Referring to these figures, it may be confirmed that the porous support according to the present disclosure has small-sized and uniform lens-shaped particles and, as the size of the particles, the short axis length of the particles (taken along line A-A′) is 90 to 150 nm, and the long axis length of the particles (taken along line B-B′) is 300 to 500 nm.

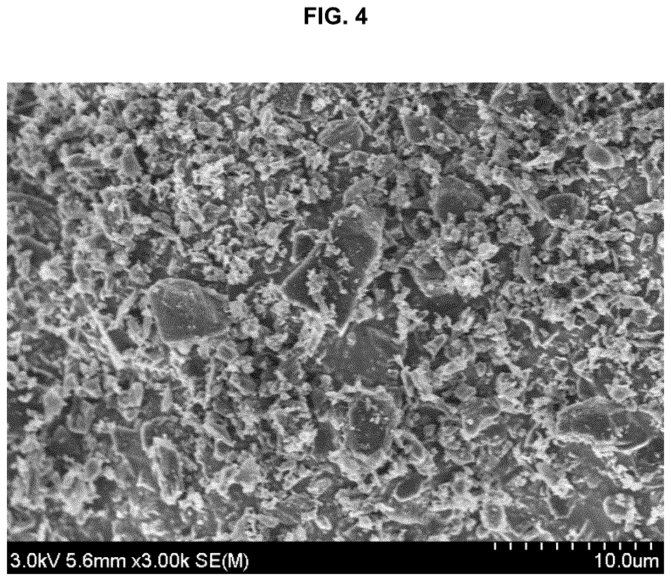

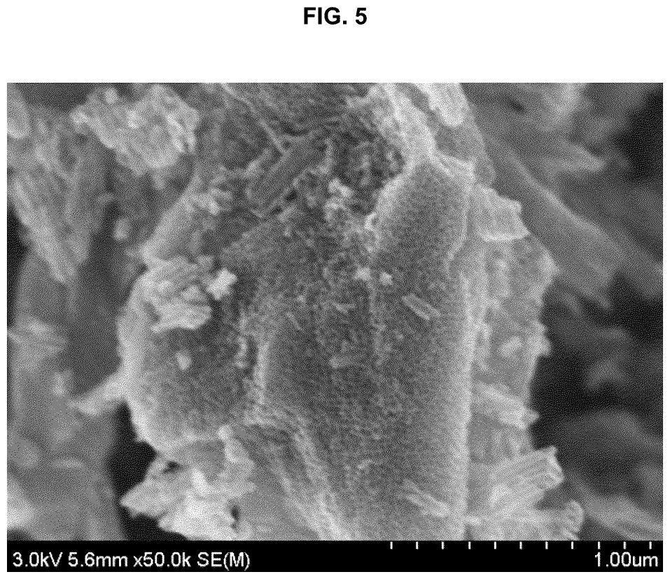

FIGS. 4 and 5 show SEM images of the porous support according to Comparative Example 1. Referring to these figures, it may be confirmed that, when polymethyl-methacrylate (PMMA) is not added, irregular particles having a relatively large size of 500 nm to 2 μm are formed.

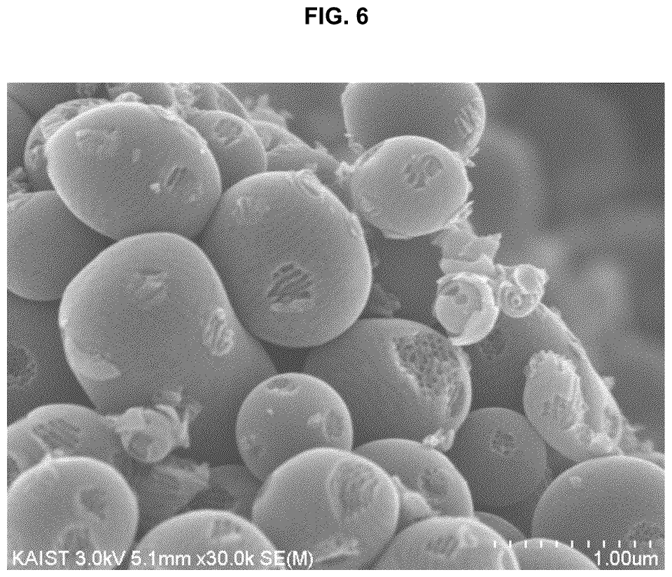

FIG. 6 shows an SEM image of the porous support according to Comparative Example 2. Referring to this figure, it may be confirmed that, when the same mass of polybutyl methacrylate (PBMA) or polystyrene rather than PMMA is used as the homopolymer, spherical particles having no pores exposed from the surface of the porous support are formed. It is estimated that the reason for this is that, as the length of a carbon functional group in each unit of the homopolymer is increased or the hydrophobicity thereof is increased, an interaction between the homopolymer and the block copolymer (PEO-b-PS) does not take place desirably, and thus, the particles are assembled so that no pores are exposed.

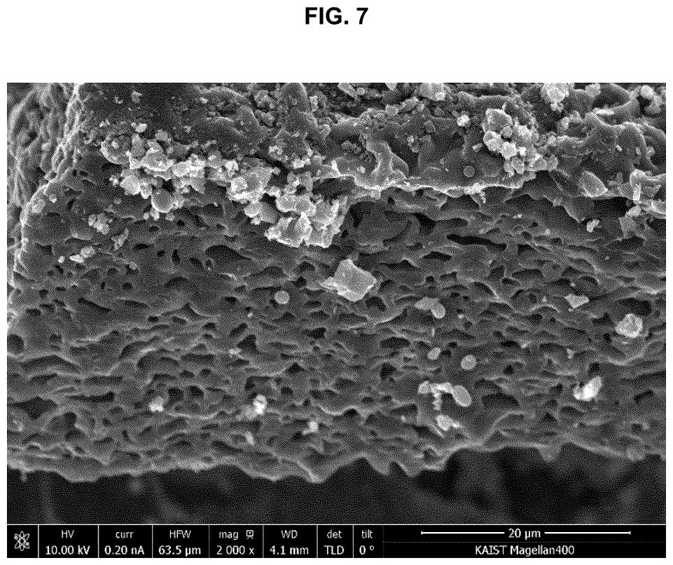

FIG. 7 shows an SEM image of the porous support according to Comparative Example 3. Referring to this figure, it may be confirmed, when the block copolymer to PMMA are mixed in a mass ratio of 1:2 deviating from the above-described given condition (i.e., the mass ratio of 1:4 to 1:10), bulk particles forming macropores rather than mesopores are produced. That is to say, the homopolymer is not capable of sufficiently spatially separating particles formed of the block copolymer and thus, the bulk particles may be produced.

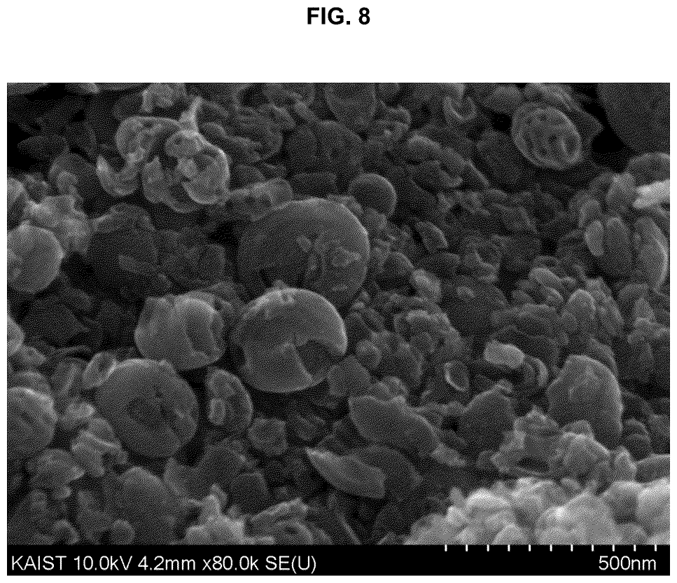

FIG. 8 shows an SEM image of the porous support according to Comparative Example 4. Referring to this figure, it may be confirmed that, when a block copolymer in which the molecular weight Mₙ of the hydrophobic functional group, i.e., polystyrene, is equal to or more than 50,000 g/mol, deviating from the above-given range of 15,000 to 40,000 g/mol, is used, pores are excessively enlarged, the structure of the support is collapsed due to a relatively small thickness of the wall compared to the pores, and a regular porous structure is not produced.

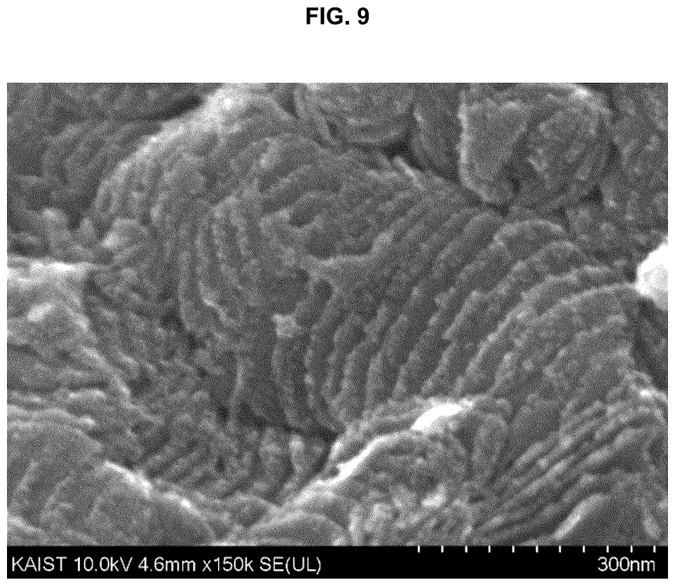

FIG. 9 shows an SEM image of the porous support according to Comparative Example 5. Referring to this figure, it may be confirmed that, when the amount of the inorganic precursor is reduced and thus the block copolymer to the inorganic precursor are mixed in a mass ratio of 1:2 compared to the porous supports according to Examples in which the block copolymer to the inorganic precursor are mixed in a mass ratio of 1:3.5 to 1:4.5, particles having a lamella structure of carbon are produced.

Results of appearance analysis are set forth in Table 2.

TABLE 2

| | | | Comp. | Comp. | Comp. | Comp. | Comp. |
|---|---|---|---|---|---|---|---|
| Category | Example 1 | Example 2 | example 1 | example 2 | example 3 | example 4 | example 5 |
| Shape | Uniform | Uniform | Irregular and | Spherical | Hierarchical | Spherical | Carbon |
| and size | lens- | lens- | relatively | porous | carbon | carbon | particles |
| of carbon | shaped | shaped | large carbon | particles | particles | particles | formed |
| support | particles | particles | particles | having no | having | having | in |
| | (short axis: | (short axis: | having a | pores | macropores | collapsed | lamella |
| | 90-150 nm, | 90-150 nm, | size of | exposed | | regular | structure |
| | long axis: | long axis: | 500 nm-2 μm | from | | porous | |
| | 300-500 nm) | 300-500 nm) | | surface | | structure | |
| | | | | of carbon | | | |
| | | | | support | | | |

### 2.2 Electrochemical Characteristic Analysis of Half-Cell

A Nafion mixed solution was prepared by mixing 5 mg of each of the porous supports on which the platinum catalyst is supported with 1.25 ml of a solvent (absolute ethanol:H₂O=4:1) and 30 μl of a Nafion solution (5 wt %), and dispersing the corresponding porous support through ultrasonication for 30 minutes. An electrode was prepared by applying 5 μl of the Nafion mixed solution to polished glassy carbon (having a diameter of 5 mm), rotating the polished glassy carbon to which the Nafion mixed solution is applied (at 500 rpm), and drying the polished glassy carbon to which the Nafion mixed solution is applied at room temperature.

After the electrode was connected to a rotating disk electrode (RDE), electrochemical measurement was performed in a 0.1 M HClO₄ solution saturated with oxygen. A graphite rod was used as a counter electrode, and reversible hydrogen electrode (RHE) was used as a reference electrode.

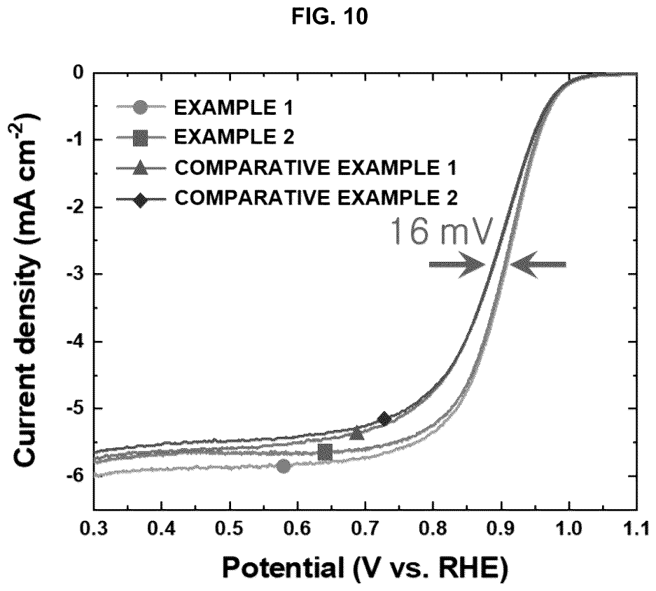

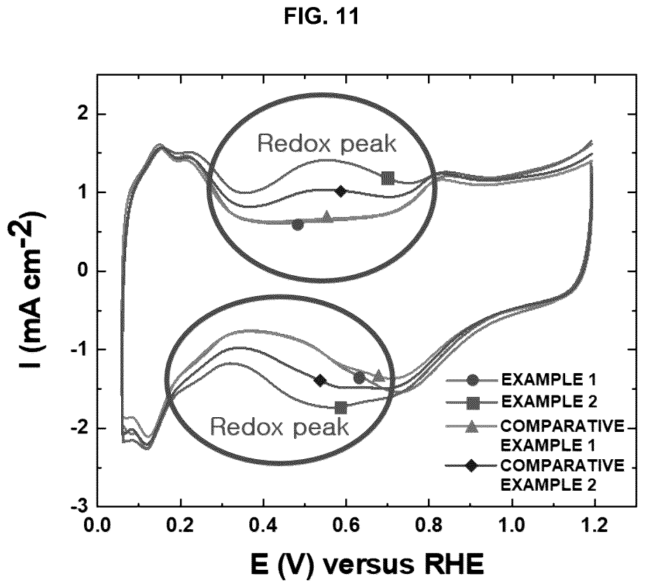

Analysis results of the electrochemical characteristics of produced half-cells are shown in FIGS. 10 and 11. In FIGS. 10 and 11, Examples and Comparative Examples indicate electrodes prepared using the porous supports according to Examples and Comparative Examples which have been described above.

As shown in FIG. 10, it may be confirmed that electrochemical performance (i.e., half-wave potential) of the porous carbon supports having small and uniform lens-shaped particles (according to Examples 1 and 2) is improved compared to the porous carbon support having large and nonuniform particles (according to Comparative Example 1) and the carbon support having no pores exposed from the surface thereof (according to Comparative Example 2).

As shown in FIG. 11, in case of the porous carbon supports in which reduction sufficiently progressed at a high temperature in a hydrogen atmosphere (according to Example 1 and Comparative Example 1), redox peaks were not formed between 0.4 V and 0.8 V through cyclic voltammetry. On the contrary, in case of the porous carbon support in which reduction did not progressed (according to Example 2) and the porous carbon support which was not sufficiently reduced (according to Comparative Example 2), redox peaks were formed between 0.4 V and 0.8 V. It seems that an undesirable oxidation-reduction reaction occurs due to an excessive amount of an oxygen functional group on the surface of the carbon support, and there is a possibility that moisture management and control ability in a unit cell system is deteriorated due to excessive hydrophilicity.

### 2-3. Unit Cell Performance Test

In order to manufacture a membrane electrode assembly and assemble a single cell, a Nafion mixed solution was prepared by mixing 8 mg of each of the porous supports on which the platinum catalyst is supported with 0.832 mL of a solvent (isopropyl alcohol:H₂O=25:1) and 82 mg of a Nafion solution (5 wt %), and dispersing the corresponding porous support through ultrasonication. A Nafion mixed solution was prepared in the same way using a commercial platinum catalyst (HiSPEC3000, Johnson Matthey).

Each Nafion mixed solution was applied to a Nafion film (NR212) using a hand spray technique (an electrode active area of 5.06 cm²). A loading amount of the catalyst (i.e., the commercial platinum catalyst) on an anode was 0.1 mg_{Pt}/cm², and a loading amount of the catalyst (i.e., the synthesized catalyst) on a cathode was 0.1 mg_{Pt}/cm². A single cell was prepared by assembling the Nafion films, to which the corresponding catalysts were applied, by a general assembly method.

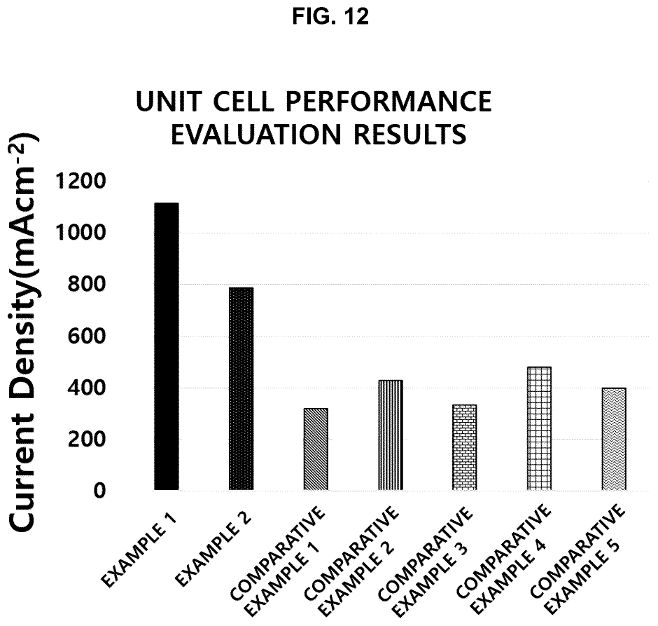

Performance of the prepared single cell was evaluated at a temperature of 80° C., a relative humidity (RH) of 100, a hydrogen flow rate of 1,000 ccm, an oxygen flow rate of 1,000 ccm, and a back pressure of 0.5 bar under the following conditions, and results thereof are shown in FIGS. 12 and Table 3.

TABLE 3

| | | | Comp. | Comp. | Comp. | Comp. | Comp. |
|---|---|---|---|---|---|---|---|
| Category | Example 1 | Example 2 | example 1 | example 2 | example 3 | example 4 | example 5 |
| *Electrochemical | 1113 | 785 | 319 | 427 | 330 | 478 | 398 |
| performance | | | | | | | |
| (mA/cm²) | | | | | | | |

*Electrochemical Performance: Current density (mA/cm²) @ 0.6 V

In FIG. 12 and Table 3, Examples and Comparative Examples indicate cells prepared using the porous supports according to Examples and Comparative Examples which have been described above.

(Activation): Each cell was maintained for 30 seconds at an open circuit voltage (OCV), was scanned at 50 mA/s, was maintained for 10 minutes at each of 1 mA/cm², 2 mA/cm², and 3 mA/cm², and was changed to the OCV and maintained for 10 seconds when voltage drops to 0.37 V or lower, and such a process was repeated (the anode:H₂ 1,000 ccm, and the cathode:O₂ 1,000 ccm).

(I-V Curve Measurement): After each cell was maintained for 1 minute at the OCV and was maintained for 4 minutes at each of specific currents, and a point obtained after stabilized for 30 seconds was used as data. When voltage drops to 0.2 V or lower, the test was terminated (the anode:H₂ 1,000 ccm, the cathode:O₂ 1,000 ccm, and the back pressure: 0.5 bar).

As shown in FIG. 12, as results of comparative evaluation of current densities of respective unit cell systems (at 0.6 V), the porous carbon supports according to Examples 1 and 2 have small and uniform lens-shaped particles and exhibit excellent cell performance compared to the supports according to Comparative Examples 1 to 5. Particularly, the porous carbon support according to Example 1, which was sufficiently reduced in the hydrogen atmosphere, exhibits the highest current density of 1113 mAcm⁻² at 0.6 V.

The supports according to Comparative Examples 1 to 5, which have compositions deviated from the preferable composition range, and thus have a bulk-type or a closed pore-type carbon particles, exhibit relatively low cell performance even though the supports were reduced into hydrogen. It is considered that a smooth oxidation-reduction reaction (ORR) did not occur due to excessive increase in an electrode thickness, when a membrane electrode assembly (MEA) was manufactured, because of large bulk-type carbon particles, or closing of inner pores.

In summary, the lens-shaped porous support according to the present disclosure, particularly, the lens-shaped porous support having the hydrophobic-treated surface, may exhibit increase in electrochemical performance and improvement in mass transfer capability when the porous support is used as a carrier for fuel cell catalysts.

### 2-4. XPS Analysis

Results of ratios of elements existing on the surfaces of the porous supports, measured by X-ray Photoelectron Spectroscopy (XPS) (using Multilab 2000, Thermo) are set forth in Table 4.

TABLE 4

| | | | Comp. | Comp. | Comp. | Comp. | Comp. |
|---|---|---|---|---|---|---|---|
| Category | Example 1 | Example 2 | example 1 | example 2 | example 3 | example 4 | example 5 |
| Oxygen | 0.1 s: | 0.1 s: | 0.1 s: | 0.1 s: | 0.1 s: | 0.1 s: | 0.1 s: |
| functional | 0.80 at % | 4.48 at % | 2.21 at % | 3.78 at % | 2.13 at % | 1.04 at % | 0.93 at % |
| group on | | | | | | | |
| surface of | | | | | | | |
| carbon | | | | | | | |
| support | | | | | | | |

As set forth in Table 4, the functional group on the surface of the carbon support may be adjusted during heat treatment in the hydrogen atmosphere, and the ratio of the oxygen functional group on the surface of the carbon support may be reduced by reducing the carbon support at a high temperature in the hydrogen atmosphere. The O_{XPS} value of the carbon support according to Example 1 was measured to be 0.08 wt % which is the lowest. When the corresponding carbon support is applied to an electrode of a fuel cell, the O_{XPS} value of the carbon support may directly affect moisture management and control ability in the unit cell system.

Even though the carbon supports are reduced in the same hydrogen atmosphere, the degrees of reduction of the carbon supports may be different depending on the shapes and sizes of the carbon supports, and this may be also confirmed through the redox peaks in cyclic voltammetry.

As is apparent from the above description, a porous support according to the present disclosure includes pores located on the surfaces of regular lens-shaped particles having a relatively small size, and may thus improve electrochemical performance of a fuel cell and increase mass transfer capability of the fuel cell when the porous support is used as a carrier to support a fuel cell catalyst.

Further, by a manufacturing method according to the present disclosure, a carbon structure having a regular lens shape may be synthesized while independently controlling the size of the pores of the porous support, and properties of the surface of the porous support may be controlled so as to have hydrophilicity or hydrophobicity.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A porous support for fuel cell catalysts, comprising:
a plurality of pores arranged at even intervals; and
wherein the porous support is configured to have an oval or convex lens shape.

2. The porous support of claim 1, wherein a size of the plurality of pores is 5 nm to 50 nm.

3. The porous support of claim 1, wherein a shape of the plurality of pores is one of a cylindrical shape, an elliptical columnar shape, a polygonal columnar shape, and combinations thereof.

4. The porous support of claim 1, wherein the plurality of pores each comprise a communication channel configured such that the plurality of pores communicate with other of the plurality of pores therethrough.

5. The porous support of claim 1, wherein a diameter of the communication channel is 0.5 to 10 nm.

6. The porous support of claim 1, wherein:
a short axis length of the porous support is 90 to 300 nm; and
a long axis length of the porous support is 300 to 1,000 nm.

7. The porous support of claim 1, wherein a surface of the porous support is hydrophobically modified.

8. A manufacturing method of a porous support for fuel cell catalysts, comprising:
preparing a mixed solution by mixing an amphiphilic block copolymer, a homopolymer, an organic precursor, an organic solvent, and an inorganic precursor;
preparing a composite by performing evaporation-induced self-assembly (EISA) of the mixed solution; and
forming the porous support through heat treatment of the composite;
wherein the porous support comprises a plurality of pores arranged at even intervals, the porous support being configured to have an oval or convex lens shape.

9. The manufacturing method of claim 8, wherein the amphiphilic block copolymer is one selected from the group consisting of poly(ethylene oxide)-b-poly(styrene), poly(ethylene oxide)-b-poly(methyl methacrylate), poly(isoprene)-b-poly(ethylene oxide), poly(isoprene)-b-poly(styrene)-b-poly(ethylene oxide), poly(4-tert-butylstyrene)-b-poly(ethylene oxide), and commercial Pluronic block copolymers comprising P123, F127 and F108.

10. The manufacturing method of claim 8, wherein the amphiphilic block copolymer comprises a hydrophilic block and a hydrophobic block, wherein:
a number-average molecular weight Mₙ of the hydrophilic block is 4,000 to 6,000 g/mol; and
a number-average molecular weight Mₙ of the hydrophobic block is 15,000 to 40,000 g/mol.

11. The manufacturing method of claim 8, wherein the inorganic precursor comprises at least one selected from the group consisting of silicon alkoxide (SiOR₄), tetraethyl orthosilicate (TEOS), aluminum-tri-sec-butoxide, and 3-glycidoxylpropyl-trimethoxysilane.

12. The manufacturing method of claim 8, wherein the organic precursor comprises at least one selected from the group consisting of phenol, phenol-formaldehyde, furfuryl alcohol, resorcinol-formaldehyde, aldehyde, sucrose, glucose, xylose, divinylbenzene, acrylonitrile, vinyl chloride, vinyl acetate, styrene, methacrylate, methyl methacrylate, ethylene glycol dimethacrylate, urea, and melamine.

13. The manufacturing method of claim 8, wherein a mass ratio of the amphiphilic block copolymer to the homopolymer is 1:3 to 1:10.

14. The manufacturing method of claim 8, wherein a mass ratio of the amphiphilic block copolymer to the inorganic precursor is 1:2.5 to 1:5.5.

15. The manufacturing method of claim 8, further comprising forming communication channels,
wherein, in forming the communication channels, the porous support is treated with an alkaline solution or an acidic solution to form the communication channels, and wherein the communication channels are configured such that the plurality of pores of the porous support communicate with other of the plurality of pores therethrough.

16. The manufacturing method of claim 8, further comprising hydrophobically modifying a surface of the porous support,
wherein, in hydrophobically modifying the surface of the porous support, the surface of the porous support is hydrophobically modified by heat-treating the porous support at a temperature of 700 to 1,000° C. for 1 to 4 hours while raising a temperature of the porous support at a heating rate of 1 to 5° C./min, in a hydrogen (H₂)/argon (Ar) or hydrogen (H₂)/nitrogen (N₂) mixed gas atmosphere comprising 3.9% to 20% (v/v %) of hydrogen.
